(19) United States
(12) Patent Application Publication
(10) Pub. No.: US 2024/0254274 A1
(43) Pub. Date: Aug. 1, 2024

(54) POLYURETHANE COMPOSITE

(71) Applicant: Covestro Deutschland AG, Leverkusen (DE)

(72) Inventors: Guobin Sun, Shanghai (CN); Yi Qing Li, Shanghai (CN); Sarah Maeker, Köln (DE); Torsten Hagen, Dortmund (DE)

(21) Appl. No.: 18/562,639

(22) PCT Filed: Jun. 28, 2022
(86) PCT No.: PCT/EP2022/067642

§ 371 Date: Nov. 20, 2023

(30) Foreign Application Priority Data
Jun. 30, 2021 (CN) 202110740715.0
Aug. 3, 2021 (EP) 21189449.8

(51) Int. Cl. C08G 18/67; C08G 18/48; C08G 18/76; C08J 5/04

(52) U.S. Cl. CPC C08G 18/672; C08G 18/4845; C08G 18/7671; C08J 5/043; C08J 2375/14

(57) ABSTRACT

The present invention relates to a polyurethane composite, a polyurethane product comprising the polyurethane composite, and use thereof in the preparation of polyurethane products.

### CROSS REFERENCE TO RELATED APPLICATIONS

This application is a U.S. national stage application, filed under 35 U.S.C. § 371, of International Application No. PCT/EP2022/067642, which was filed on Jun. 28, 2022, which claims priority to European Patent Application No. 21189449.8, which was filed on Aug. 3, 2021, and to Chinese Patent Application No. 202110740715.0 which was filed on Jun. 30, 2021. The contents of each are hereby incorporated by reference into this specification.

### TECHNICAL FIELD

The present invention relates to a polyurethane composite, a polyurethane product comprising the polyurethane composite, and use thereof in the preparation of polyurethane products.

### BACKGROUND TECHNOLOGY

The polyol composition in a polyurethane reaction system is very important, and different polyol compositions may bring different physical properties and reaction products. Particularly when used for the production of large parts such as those for wind blades, ships and the like, it is important whether the polyol composition can bring about the satisfactory pot-life, the uniform and stable filling, and the like.

Polyurethane modified resin for windmill blades and a preparation process thereof, wherein the modified resin is obtained by reacting a polyester resin, a hydroxyl-containing acrylate and an isocyanate and then diluting with unsaturated monomers or other reactive diluents are known.

Despite such disclosures, there is still a great need in the art for more suitable polyol compositions, polyurethane reaction systems and corresponding polyurethane composites to meet various needs.

### SUMMARY OF THE INVENTION

One aspect of the present invention provides a polyurethane composite prepared by mixing the following components:
a polyurethane reaction system, and
at least one reinforcing material;
wherein,
the polyurethane composite is prepared through pultrusion process, filament winding process, hand lay-up moulding process, vacuum infusion process, spray lay-up moulding process or a combination thereof;
wherein the polyurethane reaction system comprises:
   Component A), comprising at least one polyisocyante,
   Component B), comprising:
      b1) at least one polyol;
      b2) at least one compound having the structure of formula (I)

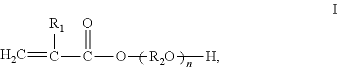

Wherein, R₁ is selected from hydrogen, methyl or ethyl;
R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene;
n is selected from an integral number of 1-6;
b3) at least one hydroxyl-free multifunctional (meth)acrylate,
Component C), a free radical reaction initiator.

Another aspect of the present invention provides a polyurethane product comprising the polyurethane composite of the present invention and the use of the polyurethane composite of the present invention in the preparation of polyurethane products.

### DETAILED DESCRIPTION

### General Definitions and Terminology

Unless otherwise specified, terms and phrases used herein have the meanings described below. Certain terms or phrases shall not be considered as unclear or indefinite when they are not specifically defined. When a trade name appears herein, it is intended to refer to its corresponding commercial product or its active ingredient(s).

Unless specifically defined otherwise or reasonably judged from the context, ratios (including percentages) or parts used herein are all by weight.

The terms “about”, “approximately” when used in conjunction with a numerical variable generally mean that the numerical value of that variable and all numerical values of that variable are within experimental errors (for example, within an average 95% confidence interval) or ±10% or a wider range of the specified numerical value.

The expression “comprising” or its equivalent expressions “including”, “containing” and “having” and the like are open and do not exclude additional unlisted elements, steps or ingredients. The expression “consisting of” excludes any element, step or ingredient not specified. The expression “consisting essentially of” means that the scope is limited to the specified elements, steps or ingredients, plus optionally existed elements, steps or ingredients that do not substantially affect the basic and new characteristics of the claimed subject matter. It should be understood that the expression “comprising” encompasses the expressions “consisting essentially of” and “consisting of”.

The term “optional” or “optionally” means that the following described event or circumstance may or may not occur, and that the description includes both the occurrence of the event or circumstance and the non-occurrence of the event or circumstance.

The expressions “one or more” or “at least one” can mean 1, 2, 3, 4, 5, 6, 7, 8, 9, or more.

The term “and/or” encompasses “and” as well as “or”. Elements defined with “and/or” are meant to encompass any one and any combination thereof. For example, A and/or B encompasses A, B, and A+B. A, B and/or C then encompasses A, B, C, A+B, A+C, B+C and A+B+C.

### I. Polyol Compositions

The present invention provides a polyol composition comprising:
b1) at least one polyol;
b2) at least one compound having the structure of formula (I)

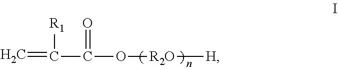

Wherein, R₁ is selected from hydrogen, methyl or ethyl; R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene; n is selected from an integral number of 1-6;
b3) at least one hydroxyl-free multifunctional (meth)acrylate.

In an embodiment, said b1) component is selected from one or more organic polyol having the functionality of 1.7-6, and the hydroxyl value of 150-1100 mg KOH/g (Test Method ISO 14900-2017).

In a preferred embodiment, said b1) component is a propylene oxide-based polyether polyol, with glycerol as starter, functionality=3, and hydroxyl value 350 mg KOH/g.

In another embodiment, the content of said b1) component is 9-60 wt %, preferably 10-60 wt %, based on the total weight of the polyurethane reaction system.

In an embodiment, the b2) component is selected from: hydroxyethyl methacrylate, hydroxypropyl methacrylate, hydroxybutyl methacrylate, hydroxyethyl acrylate, hydroxypropyl acrylate, hydroxybutyl acrylate or a combination thereof, preferably hydroxypropyl methacrylate.

As for b3) component, hydroxyl-free multifunctional (meth)acrylate refers to a substance being free of hydroxyl group but containing two or more (meth)acrylic acid ester groups in the molecule structure.

In an embodiment, said b3) component is selected from ethylene glycol di(meth)acrylate, propylene glycol di(meth)acrylate, butylene glycol di(meth)acrylate, 1,6-hexylene glycol di(meth)acrylate, diethylene glycol di(meth)acrylate, triethylene glycol di(meth)acrylate, dipropylene glycol di(meth)acrylate, tripropylene glycol di(meth)acrylate, trimethylolpropane tri(meth)acrylate, 1,2,3-glycerol tri(meth)acrylate, pentaerythritol tetra(meth)acrylate or any combination thereof, preferably 1,6-hexylene glycol di(meth)acrylate, trimethylolpropane tri(meth)acrylate, or a combination thereof: such as 1,6-hexylene glycol di(meth)acrylate, trimethylolpropane tri(meth)acrylate, or a combination thereof.

In another embodiment, the content of said b3) component is 1.8-42 wt %, preferably 2.2-36.1 wt %, more preferably 2.47-20.1 wt %, particularly preferably 2.8-18.8 wt %, more particularly preferably 3.8-17.6 wt %, based on the total weight of the polyol composition.

### II. Polyurethane Reaction System

The present invention provides a polyurethane reaction system, comprising:
Component A), comprising: at least one polyisocyanate;
Component B), comprising: the polyol composition of the present invention;
Component C): a free radical reaction initiator.

In a specific embodiment, the polyurethane reaction system of the present invention comprises:
Component A), comprising: at least one polyisocyanate;
Component B), comprising:
b1) at least one polyol;
b2) at least one compound having the structure of formula (I)

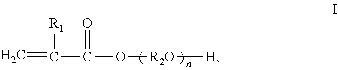

Wherein, R₁ is selected from hydrogen, methyl or ethyl; R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene; n is selected from an integral number of 1-6;
b3) at least one hydroxyl-free multifunctional (meth)acrylate;
Component C): a free radical reaction initiator.

### Component A)

In embodiments of the present invention, said polyisocyanate can be an organic polyisocyanate. The organic polyisocyanate may be any aliphatic, cycloaliphatic, or aromatic isocyanate known to be used in the preparation of polyurethanes. Its examples include, but is not limited to: toluene diisocyanate (TDI), diphenylmethane diisocyanate (MDI), polyphenylmethane polyisocyanate (pMDI), 1,5-naphthalene diisocyanate (NDI), hexamethylene diisocyanate (HDI), methylcyclohexyl diisocyanate (TDI), 4,4′-dicyclohexylmethane diisocyanate, isophorone diisocyanate (IPDI), p-phenylene diisocyanate (PPDI), p-xylylene diisocyanate (XDI), tetramethyldimethylene diisocyanate (TMXDI) and their polymers or a combination thereof.

In an embodiment, the functionality of the isocyanate that can be used in the present invention is preferably 2.0-3.5, particularly preferably 2.1-2.9.

In another embodiment, the viscosity of the isocyanate is preferably 5-700 mPa·S, particularly preferably 10-300 mPa. S, measured at 25° C. according to DIN 53019-1-3.

In a preferred embodiment, the isocyanate has a NCO content of 30.5-32.5 wt %, a viscosity of 160-240 mP·s at 25° C.

When used in the present invention, the (organic) polyisocyanate may comprise an isocyanate dimer, an isocyanate trimer, an isocyanate tetramer, an isocyanate pentamer, or a combination thereof.

In preferred embodiments of the present invention, the isocyanate component A) may comprise diphenylmethane diisocyanate (MDI), polyphenylmethane polyisocyanate (pMDI), and their polymers, prepolymers or a combination thereof.

A terminated-isocyanate may also be used as isocyanate component A), which may be prepared by the reaction of an excessive amount of an organic polyisocyanate or an organic polyisocyanate mixture with a polyol compound. Those of ordinary skill in the art are familiar with these compounds and their preparation methods.

In an embodiment, the NCO content of the (organic) polyisocyanate of the present invention is 20-33 wt %, preferably 25-32 wt %, particularly preferably 30-32 wt %. The NCO content is determined by GB/T 12009.4-2016.

The organic polyisocyanates can also be used in the form of polyisocyanate prepolymers. These polyisocyanate prepolymers can be obtained by reacting an excess of the above-mentioned organic polyisocyanate with a compound having at least two isocyanate-reactive groups at a temperature of for example 30-100° C., preferably about 80° C. In an embodiment, the NCO content of the polyisocyanate prepolymer of the present invention is 20-33 wt %, preferably 25-32 wt %. The NCO content is determined by GB/T 12009.4-2016.

In a preferred embodiment, the polyisocyanate content of the present invention is ≤65 wt %, preferably ≤60 wt %, more preferably 30-45 wt %, based on the total weight of the polyurethane reaction system.

### Component B)

Description of components b1), b2) and b3) can be found above.

In an embodiment, the content of the b1) component is 40-60 wt %, preferably 45-55 wt %, such as 44, 48, 52, 55%, based on the total weight of the polyol composition or the total weight of the component B.

In another embodiment, the content of said b1) component is 10-60 wt %, preferably 20-60 wt %, based on the total weight of the polyurethane reaction system.

In an embodiment, the content of said b2) component is 25-40 wt %, preferably 30-36 wt %, such as 30, 32, 35, 36 wt %, based on the total weight of the polyol composition or the total weight of the component B.

In another embodiment, the content of said b2) component is 3-34 wt %, preferably 5-33 wt %, based on the total weight of the polyurethane reaction system.

In an embodiment, the content of said b3) component is 5-35 wt %, preferably 9-30 wt %, such as 9, 10, 12, 13, 15, 18, 20, 22, 25, 26 wt %, based on the total weight of the polyol composition or the total weight of the component B.

In another embodiment, the content of said b3) component is 1-18 wt %, preferably 1.2-16 wt %, more preferably 1.3-9.6 wt %, particularly preferably 1.5-9 wt %, more particularly preferably 2-8.5 wt %, based on the total weight of the polyurethane reaction system. For example, the content of said b3) component can be 1, 1.2, 1.3, 1.5, 2, 5, 7.4, 8.5, 9, 9.6, 11.7, 15.7, 16, 18 wt %, based on the total weight of the polyurethane reaction system.

In embodiments of the present invention, the isocyanate-reactive component/polyurethane reaction system may contain one or more organic polyols b1). The content of the organic polyol is 9-60 wt %, based on 100 wt % of the total weight of the polyurethane reaction system. The organic polyol may be an organic polyol conventionally used in the art for preparing a polyurethane, and comprises, but is not limited to: polyether polyol, polyethercarbonate polyol, polyester polyol, polycarbonate diol, polymer polyol, vegetable oil-based polyol, or a combination thereof.

The polyether polyol can be prepared by known processes, for example, obtained by reacting an olefin oxide with a starter in the presence of a catalyst. The catalyst is preferably, but not limited to, an alkaline hydroxide, an alkaline alkoxide, antimony pentachloride, boron fluoride etherate, or a mixture thereof. The olefin oxide is preferably, but not limited to, tetrahydrofuran, ethylene oxide, propylene oxide, 1,2-butylene oxide, 2,3-butylene oxide, styrene oxide, or a mixture thereof, particularly preferably ethylene oxide and/or propylene oxide. The starter is preferably, but not limited to, polyhydroxyl compounds or polyamine compounds, the polyhydroxyl compound is preferably, but not limited to, water, ethylene glycol, 1,2-propylene glycol, 1,3-propylene glycol, diethylene glycol, trimethylolpropane, glycerol, bisphenol A, bisphenol S or a mixture thereof, and the polyamine compound is preferably, but not limited to, ethylene diamine, propylene diamine, butylene diamine, hexamethylene diamine, diethylene triamine, toluylene diamine or a mixture thereof.

The polyethercarbonate polyol may also be used in the present invention. The polyethercarbonate polyol can be prepared by adding carbon dioxide and alkylene oxide on an active hydrogen-containing starter by means of a double metal cyanide catalyst.

Said polyester polyol is prepared by reacting dicarboxylic acid or dicarboxylic anhydride with polyol. The dicarboxylic acid is preferably, but not limited to, an aliphatic carboxylic acid having 2-12 carbon atoms, and the aliphatic carboxylic acid having 2-12 carbon atoms is preferably, but not limited to, succinic acid, malonic acid, glutaric acid, adipic acid, suberic acid, azelaic acid, sebacic acid, lauryl acid, maleic acid, fumaric acid, phthalic acid, isophthalic acid, terephthalic acid, or a mixture thereof. The dicarboxylic anhydride is preferably, but not limited to, phthalic anhydride, tetrachlorophthalic anhydride, maleic anhydride, or a mixture thereof. The polyol that is reacted with dicarboxylic acid or dicarboxylic anhydride is preferably, but not limited to ethylene glycol, diethylene glycol, 1,2-propylene glycol, 1,3-propylene glycol, dipropylene glycol, 1,3-methylpropylene glycol, 1,4-butylene glycol, 1,5-pentylene glycol, 1,6-hexylene glycol, neopentyl glycol, 1,10-decanediol, glycerol, trimethylolpropane, or a mixture thereof. The polyester polyol also comprises a polyester polyol prepared from lactone. The polyester polyol prepared from lactone is preferably, but not limited to &-caprolactone. Preferably, the polyester polyol has a molecular weight of 200-3000 and a functionality of 2-6, preferably 2-4, and more preferably 2-3.

The polycarbonate diol can be prepared by reacting a diol with a dihydrocarbyl carbonate or a diaryl carbonate or phosgene. The diol is preferably, but not limited to, 1,2-propylene glycol, 1,3-propylene glycol, 1,4-butylene glycol, 1,5-pentylene glycol, 1,6-hexylene glycol, diethylene glycol, trioxymethylene diol, or a mixture thereof. The dihydrocarbyl carbonate or the diaryl carbonate is preferably, but not limited to, diphenyl carbonate.

As polyols, biobased polyether polyols can also be used. Examples include, but not limited to, vegetable oil-based polyols, such as, but not limited to, vegetable oils, vegetable oil polyols, or modified products thereof. As examples of biobased polyether polyols, cardanol-modified polyether polyols can also be used.

When used in the present invention, the vegetable oil-based polyol may include a vegetable oil, a vegetable oil polyol or a modified product thereof. The vegetable oil is a compound prepared from an unsaturated fatty acid and glycerol, or is an oil and fat extracted from fruits, seeds and germs of plants, and is preferably, but not limited to, peanut oil, soybean oil, linseed oil, castor oil, rapeseed oil, and palm oil. The vegetable oil polyol is a polyol initiated from one or more vegetable oils. The starter for synthesizing the vegetable oil polyol includes, but is not limited to, soy bean oil, palm oil, peanut oil, low erucic acid rapeseed oil, and castor oil. A hydroxyl group can be introduced into the starter of the vegetable oil polyol through the process such as cracking, oxidation, or transesterification, and then the corresponding vegetable oil polyol can be prepared by a process for preparing an organic polyol well known to those skilled in the art.

When used in the present invention, unless otherwise specified, the functionality and the hydroxyl value of the organic polyol refer to the average functionality and the average hydroxyl value. Methods for measuring the hydroxyl value are familiar to those skilled in the art. If not otherwise mentioned, hydroxyl values in this application are determined according Test Method ISO 14900-2017. When used in the present invention, unless otherwise specified, the functionality and the hydroxyl value of the organic polyol refer to the average functionality and the average hydroxyl value.

In embodiments of the present invention, the isocyanate-reactive component/polyurethane reaction system may further contain one or more compounds b2) having the structure of formula (I)

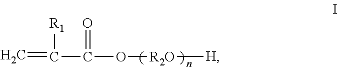

Wherein, R₁ is selected from hydrogen, methyl or ethyl; R₂ is selected from an alkylene group having 2-6 carbon atoms; n is an integral number selected from 1-6.

In a preferred embodiment of the present invention, R₂ is selected from ethylene, propylene, butylene, pentylene, 1-methyl-1,2-ethylene, 2-methyl-1,2-ethylene, 1-ethyl-1,2-ethylene, 2-ethyl-1,2-ethylene, 1-methyl-1,3-propylene, 2-methyl-1,3-propylene, 3-methyl-1,3-propylene, 1-ethyl-1,3-propylene, 2-ethyl-1,3-propylene, 3-ethyl-1,3-propylene, 1-methyl-1,4-butylene, 2-methyl-1,4-butylene, 3-methyl-1,4-butylene and 4-methyl-1,4-butylene, 2,2-bis(4-phenylene)-propane, 1,4-dimethylenebenzene, 1,3-dimethylenebenzene, 1,2-dimethylenebenzene.

In a preferred embodiment of the present invention, the component b2) can be selected from: hydroxyethyl methacrylate, hydroxypropyl methacrylate, hydroxybutyl methacrylate, hydroxyethyl acrylate, hydroxypropyl acrylate, hydroxybutyl acrylate or a combination thereof, preferably hydroxypropyl methacrylate.

The compound of formula (I) may be prepared by conventional methods in the art, for example may be prepared by the esterification reaction of (meth)acrylic anhydride or (meth)acrylic acid, (meth)acryloyl halide compounds and HO—(R₂O)ₙ—H.

The hydroxyl-free multifunctional (meth)acrylate refers to a substance being free of hydroxyl group but containing two or more (meth)acrylic acid ester groups in the molecule structure.

In an embodiment, the b3) component can be selected from ethylene glycol di(meth)acrylate, propylene glycol di(meth)acrylate, butylene glycol di(meth)acrylate, 1,6-hexylene glycol di(meth)acrylate, diethylene glycol di(meth)acrylate, triethylene glycol di(meth)acrylate, dipropylene glycol di(meth)acrylate, tripropylene glycol di(meth)acrylate, trimethylolpropane tri(meth)acrylate, 1,2,3-glycerol tri(meth)acrylate, pentaerythritol tetra(meth)acrylate or any combination thereof, preferably 1,6-hexylene glycol di(meth)acrylate, trimethylolpropane tri(meth)acrylate, or a combination thereof: such as 1,6-hexylene glycol di(meth)acrylate, trimethylolpropane tri(meth)acrylate, or a combination thereof.

In another embodiment, the content of said b3) component is 1.8-42 wt %, preferably 2.2-36.1 wt %, more preferably 2.47-20.1 wt %, particularly preferably 2.8-18.8 wt %, more particularly preferably 3.8-17.6 wt %, based on the total weight of the polyol composition.

After repeated experiments, the inventors surprisingly found that the polyol composition of the present invention, which comprises a hydroxyl-free multifunctional (meth)acrylate and a polyol compatible thereto, and a compound having the structure of formula (I), can extend the pot-life of the corresponding polyurethane reaction system, and simultaneously the linear shrinkage rate can also be increased. However, if the linear shrinkage rate exceeds a certain value, the requirement for a specific application may not be satisfied. In a preferred embodiment of the present invention, the polyurethane reaction system comprising a specific content of the hydroxyl-free multifunctional (meth)acrylate and other components compatible thereto can extend the pot life and increase the linear shrinkage rate so that a preferred range satisfying certain requirements can be reached.

Thus, in an embodiment, the polyurethane reaction system has a pot-life at 35° C. of ≥68 minutes, preferably ≥70 minutes, more preferably ≥72 minutes, particularly preferably ≥80 minutes.

In an embodiment, compared to the pot-life at 35° C. of a polyurethane reaction system without b3) component, the pot-life at 35° C. of said polyurethane reaction system with b3) component is increased by ≥5%, preferably ≥10%, more preferably ≥15%.

Pot-life refers to the time from stirring the components of the reaction system uniformly until the viscosity of the mixture reaches 600 mPa·S. For example, the pot-life can be measured in the following manner: components of the polyurethane reaction system are thermostatically treated at 35° C. respectively, and then mixed in the required proportion: the mixture is stirred for 1 minute until the mixture is mixed uniformly; under the temperature being maintained at 35° C., the viscosity of the mixture is measured once every 3 minutes, and the time required until the viscosity reaches 600 mPa·S is recorded as the pot-life. As viscometer Product DV2TLTJ0 from Brook-Field Corporation can be used.

In an embodiment, the polyurethane reaction system has a linear shrinkage rate of ≤0.95%, preferably ≤0.90%, more preferably ≤0.80% (Test Method ISO2577-2007).

Linear shrinkage rate refers to the linear shrinkage rate of a resin obtained from the reaction of a polyurethane reaction system measured according to test standard ISO 2577-2007.

### Component C)

In embodiments of the present invention, the polyurethane reaction system further contains C) free radical reaction initiator. The free-radical initiator that is used in the present invention may be added to the polyol component or the isocyanate component, or can be added to both components. These initiators include, but are not limited to, peroxide, persulfide, peroxycarbonate, boric acid peroxide, azo compound, or other suitable free radical initiators that can initiate the curing of a double bond-containing compound. An example thereof includes tert-butyl peroxyisopropylcarbonate, tert-butyl peroxy-3,5,5-trimethylhexanoate, methylethyl ketone peroxide, and cumene hydroperoxide.

The content of the free-radical reaction initiator is usually 0.1-8 wt %, based on 100 wt % of the total weight of the isocyanate-reactive component. In addition, an accelerator, such as a cobalt compound or an amine compound, may be present.

In embodiments of the present invention, the polyurethane reaction system may also contain a catalyst for catalyzing the reaction of an isocyanate group (NCO) and a hydroxyl group (OH). An appropriate catalyst for the polyurethane reaction is preferably, but not limited to an amine catalyst, an organometallic catalyst, or a mixture thereof. The amine catalyst is preferably, but not limited to triethylamine, tributylamine, triethylenediamine, N-ethylmorpholine, N,N,N′, N′-tetramethyl-ethylene diamine, pentamethyldiethylene-triamine, N,N-methylaniline, N,N-dimethylaniline, or a mixture thereof. The organometallic catalyst is preferably, but not limited to an organotin-type compound, for example: tin (II) acetate, tin (II) octoate, tin ethylhexanoate, tin laurate, dibutyltin oxide, dibutyltin dichloride, dibutyltin diacetate, dibutyltin maleate, dioctyltin diacetate, or a mixture thereof. The used amount of the catalyst is 0.001-10 wt %, based on 100 wt % of the total weight of the isocyanate-reactive component.

In embodiments of the present invention, the polyurethane reaction, i.e., the addition polymerization reaction between the isocyanate group and the hydroxyl group, wherein the isocyanate group can be an isocyanate group contained in the organic polyisocyanate (component A), or an isocyanate group contained in the intermediate product of the reaction of the organic polyisocyanate (component A) and the organic polyol (b1) component) or b2) component, the hydroxyl group can be a hydroxyl group contained in the organic polyol (b1) component) or b2) component, or a hydroxyl group contained in the intermediate product of the reaction of the organic polyisocyanate (component A) and the organic polyol (b1) component) or b2) component.

In embodiments of the present invention, the free-radical polymerization reaction is an addition polymerization reaction of olefinic bonds, wherein the olefinic bonds may be an olefinic bond contained in b2) component or an olefinic bond contained in the intermediate product of the reaction of b2) component and the organic polyisocyanate.

In embodiments of the present invention, the polyurethane addition polymerization reaction (i.e., the addition polymerization reaction between the isocyanate group and the hydroxyl group) and the free radical polymerization reaction coexist. As known to those skilled in the art, suitable reaction conditions can be selected to allow the polyurethane addition polymerization reaction and the free radical polymerization reaction to proceed successively, but the polyurethane matrix prepared in this way is structurally different from the polyurethane resin matrix prepared by allowing the polyurethane addition polymerization reaction and the free radical polymerization reaction to proceed simultaneously, so that the prepared polyurethane composites are different in mechanical properties and manufacturability.

In embodiments of the present invention, the above-mentioned polyurethane reaction system can also contain auxiliaries or additives comprising, but not limited to: filler, internal release agent, flame retardant, smoke suppressant, dye, pigment, antistatic agent, antioxidant, UV stabilizer, diluent, defoamer, coupling agent, surface wetting agent, leveling agent, water-removing agent, catalyst, molecular sieve, thixotropic agent, plasticizer, foaming agent, foam stabilizing agent, foam stabilizer, free radical reaction suppressant or a combination thereof, and these component may be optionally contained in the isocyanate component A) and/or the isocyanate-reactive component B). These components can also be independently stored as component D) and, when used for preparing a polyurethane composite, are mixed with the isocyanate component A) and/or the isocyanate-reactive component B) before the preparation.

In some embodiments of the present invention, the filler includes, but not limited to: aluminum hydroxide, bentonite, pulverized fuel ash, wollastonite, perlite powder, hollow microsphere, calcium carbonate, talcum powder, mica powder, porcelain clay, fumed silica, expandable microsphere, diatomite, volcanic ash, barium sulfate, calcium sulfate, glass microsphere, stone powder, wood flour, wood chip, bamboo powder, bamboo chip, rice grain, straw chips, sorghum straw chips, graphite powder, metal powder, thermosetting composite recycled powder, plastic particle or powder, or a combination thereof. Among others, the glass microspheres can be solid or hollow.

The internal release agent that can be used in the present invention comprises any release agent conventionally used for producing polyurethanes, and examples thereof include, but not limited to, long-chain carboxy lic acids, particularly fatty acids such as stearic acid, amines of long-chain carboxylic acids such as stearic amide, fatty acid esters, metal salts of long-chain carboxylic acids such as zinc stearate, or polysiloxanes.

Examples of flame retardants that can be used in the present invention include, but not limited to, triaryl phosphates, trialkyl phosphates, triaryl phosphates or trialkyl phosphates with halogen, melamine, melamine resins, halogenated paraffins, red phosphorus, or combinations thereof.

Other auxiliaries that can be used in the present invention include, but not limited to, water-scavengers such as molecular sieves; defoamers such as polydimethyl siloxane; coupling agents such as mono(ethylene oxide) or organic amine functionalized trialkoxysilane or combinations thereof. Coupling agents are particularly preferably for improving the adhesion of the resin matrix to the fiber-reinforced material. Fine particle fillers, such as clay and fumed silica, are commonly used as thixotropic agent.

The free radical reaction suppressant that can be used in the present invention comprises, but not limited to, a polymerization inhibitor and a polymerization retarder, and the like, for example, some phenols, quinone compounds or hindered amine compounds. Examples thereof include, but not limited to, methyl hydroquinone, p-methoxyphenol, benzoquinone, polymethyl piperidine derivatives, low-valent copper ions, and the like.

The present invention also correspondingly provides a polyurethane resin prepared by the reaction of the polyurethane reaction system of the present invention and the use of the polyurethane reaction system of the present invention in the preparation of polyurethane products. The polyurethane products include wind blades.

### III. Preparation of Polyurethane Composite

The present invention further provides a process for preparing a polyurethane composite, wherein the polyurethane composite contains a polyurethane resin matrix and a reinforcing material, the process comprises a step of preparing the polyurethane resin matrix under such a reaction condition that the polyurethane reaction system is subjected to the free radical polymerization reaction and the reaction between the isocyanate group and the hydroxyl group simultaneously, wherein the polyurethane reaction system is described above.

In a specific embodiment, the method includes mixing the following components to prepare the polyurethane composite:
the polyurethane reaction system of the present invention, and
at least one reinforcing material.

In an embodiment, the polyurethane composite is prepared through pultrusion process, filament winding process, hand lay-up moulding process, vacuum infusion process, spray lay-up moulding process or a combination thereof. Preferably, the polyurethane composite is prepared through pultrusion process and/or vacuum infusion process.

In embodiments of the present invention, the polyurethane addition polymerization reaction (i.e., the addition polymerization reaction between the isocyanate group and the hydroxyl group) and the free radical polymerization reaction coexist.

The polyurethane composite of the present invention can be prepared by a polyurethane vacuum infusion process. The operation procedure for the polyurethane vacuum infusion process is well known to those skilled in the art.

In the vacuum infusion process, one or more core materials are provided in a mould, and the core material is optionally covered wholly or partly by a reinforcing material. Then, a negative pressure is formed in the mould to perfuse the polyurethane resin into the mould: before curing, the polyurethane resin will wholly soak the reinforcing material and the core material will be wholly or partly soaked by the polyurethane resin. Then, under appropriate conditions, the polyurethane resin is allowed to simultaneously undergo the polyurethane addition polymerization reaction and the free-radical polymerization reaction, thereby curing the polyurethane resin to form a polyurethane resin matrix. In the above vacuum infusion process, the mould may be a mould commonly used in the art, and a person skilled in the art may select a suitable mould according to the desired properties and dimensions of the final product. In case of preparing a large article by using the vacuum infusion process, in order to ensure a sufficient pot-life, it is necessary to have the resin to keep a sufficiently low viscosity during the infusion to maintain good flowability. If the viscosity is higher than 600 mPas, the resin viscosity is considered as being too high, the flowability becomes worse, and the resin is no longer suitable for the vacuum infusion process.

The core material is used together with the polyurethane resin matrix and the reinforcing material so as to facilitate the molding of the composite material and the reduction of the weight of the composite material. The core materials commonly used in the art can be used in the polyurethane composite of the present invention, and their examples include, but not limited to polystyrene foams, for example COMPAXX® foam: polyester PET foams: polyimide PMI foams: polyvinyl chloride foams: metal foams, such as those available from Mitsubishi: balsa wood: and the like.

In an embodiment, the reinforcing material may refer to a material including glass fiber, carbon nanotube, carbon fiber, polyester fiber, natural fiber, aromatic polyamide fiber, nylon fiber, basalt fiber, boron fiber, silicon carbide fibre, asbestos fiber, crystal whisker, hard particles, metal fibre or a combination thereof. In another embodiment, the content of the reinforcing material is ≥40 wt %, preferably ≥45 wt %, more preferably 50-88 wt %, based on the total weight of the polyurethane composite.

The polyurethane reaction system of the present invention is suitable for the polyurethane vacuum infusion process to prepare the polyurethane composite, and has a relatively long pot-life, and the polyurethane composite prepared by the polyurethane vacuum infusion process has good mechanical properties, especially a relatively high heat-deflection temperature, so that the problem that the pot-life of the polyurethane reaction system and the heat-deflection temperature of the prepared polyurethane composite cannot be improved at the same time in the prior art is solved. These Polyurethane composites can be used in the production of blades of wind-driven generators, enclosures for wind-driven generators, ship blades, ship shells, internal and external decorations and shells of vehicles, radar housings, structural part materials of mechanical equipment, and decorations and structural parts of buildings and bridges. Thus, the present invention also provides the use of the polyurethane reaction system in the preparation of these materials.

The polyurethane composite of the present invention can also be prepared through the pultrusion process, the filament winding process, the hand lay-up moulding process, the spray lay-up moulding process or a combination thereof. These processes are known from prior art.

### IV. Polyurethane Composite

Therefore, the present invention also provides a polyurethane composite prepared by the method for preparing a polyurethane composite described in the present invention. Specifically, it is prepared by mixing the polyurethane reaction system of the present invention with at least one reinforcing material.

In an embodiment, the present invention provides a polyurethane composite prepared by mixing the following components:
a polyurethane reaction system, and
at least one reinforcing material;
wherein,
the polyurethane composite is prepared through pultrusion process, filament winding process, hand lay-up moulding process, vacuum infusion process, spray lay-up moulding process or a combination thereof;
wherein the polyurethane reaction system comprises:
component A), comprising at least one polyisocyante,
component B), comprising:
b1) at least one polyol;
b2) at least one compound having the structure of formula (I)

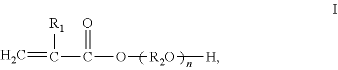

Wherein, R₁ is selected from hydrogen, methyl or ethyl; R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene; n is selected from an integral number of 1-6;
b3) at least one hydroxyl-free multifunctional (meth)acrylate,
component C), a free radical reaction initiator.

Said component A), component B), component C) and component b1), component b2), component b3) and other components are as described above, respectively.

As described above, the polyurethane reaction system comprises components A)-C).

In an embodiment, the polyurethane reaction system has a pot-life at 35° C. of ≥68 minutes, preferably ≥70 minutes, more preferably ≥72 minutes, particularly preferably ≥80 minutes.

In another embodiment, compared to the pot-life at 35° C. of a polyurethane reaction system without b3), the pot-life at 35° C. of said polyurethane reaction system with b3) is increased by ≥5%, preferably ≥10%, more preferably ≥15%.

In yet another embodiment, the polyurethane reaction system has a linear shrinkage rate of ≤0.95%, preferably ≤0.90%, more preferably ≤0.80% (Test Method ISO 2577-2007).

In a preferred embodiment, the polyurethane composite is prepared through pultrusion process and/or vacuum infusion process.

In another embodiment, the process for the preparation of the polyurethane composite comprises the coexistence of the free radical polymerization reaction and the addition polymerization reaction between isocyanate groups and hydroxyl groups.

The reinforcing material used in the polyurethane composite of the present invention can be selected from glass fiber, carbon nanotube, carbon fiber, polyester fiber, natural fiber, aromatic polyamide fiber, nylon fiber, basalt fiber, boron fiber, silicon carbide fiber, asbestos fiber, crystal whisker, hard particles, metal fiber or a combination thereof. In an embodiment, the content of the reinforcing material is ≥40 wt %, preferably ≥45 wt %, more preferably 50-88 wt %, based on the total weight of the polyurethane composite.

### V. Polyurethane Product

The present invention also provides a polyurethane product including the polyurethane composite of the present invention. In addition, the present invention also provides the use of the polyurethane composite of the present invention in the preparation of polyurethane products.

The polyurethane product can be selected from cable trays, frames of doors, windows and curtain walls, frames of ladders, tent poles or pipes, anti-glare shields, floors, sucker rods, telegraph poles and cross arms, guardrails, grills, architectural sectional materials, container sectional materials and plates, bike racks, fishing rods, cable cores, insulator core rods, antenna housings, single-layer or sandwiched continuous plates, wind blades and parts thereof, enclosures for wind-driven generators, ship blades, ship shells, internal and external decorations and shells of vehicles, radar housings, structural part materials of mechanical equipment, decorations and structural parts of buildings and bridges, preferably wind blades or parts thereof, enclosures for wind-driven generators, more preferably blade shells, web, spar caps, main spars, auxiliary spars and blade roots of wind blades.

### Beneficial Effects

The inventors have surprisingly found that the polyurethane reaction system of the present invention comprising the polyol composition of components b1) to b3), the isocyanate and the free radical reaction initiator can not only produce polyurethane products with excellent quality, but also bring about longer pot-life, and for preparing polyurethane products, especially polyurethane products with relatively large size such as wind blades, ships and the like, can gain enough pot-life for uniform filling and curing of the products.

The inventors further surprisingly found that the polyol composition of the present invention comprising a hydroxyl-free polyfunctional (meth)acrylate, together with corresponding polyol composition comprising polyol and a compound having the structure of formula (I), can prolong the pot-life of the corresponding polyurethane reaction system, thereby gaining sufficient pot-life when a polyurethane resin or composite is prepared. Thereby a uniform and perfect filling of the prepared parts, especially large parts such as wind blades, ships and the like can be achieved. In this way, the yield and production efficiency can be improved, the waste of raw materials can be reduced or avoided, and thus is more environmentally friend.

Exemplary embodiments of the present invention can be listed as follows.

Embodiment 1. A polyol composition, comprising:
b1) at least one polyol;
b2) at least one compound having the structure of formula (I)

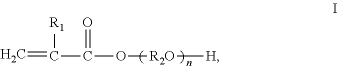

Wherein, R₁ is selected from hydrogen, methyl or ethyl; R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene; n is selected from an integral number of 1-6;
b3) at least one hydroxyl-free multifunctional (meth)acrylate.

Embodiment 2. The polyol composition according to embodiment 1, characterized in that said b3) component is selected from ethylene glycol di(meth)acrylate, propylene glycol di(meth)acrylate, butylene glycol di(meth)acrylate, 1,6-hexylene glycol di(meth)acrylate, diethylene glycol di(meth)acrylate, triethylene glycol di(meth)acry late, dipropylene glycol di(meth)acrylate, tripropylene glycol di(meth)acrylate, trimethylolpropane tri(meth)acrylate, 1,2,3-glycerol tri(meth)acry late, pentaerythritol tetra(meth)acrylate, or a combination thereof.

Embodiment 3. The polyol composition according to embodiment 1 or 2, characterized in that the content of said b3) component is 1.8-42 wt %, preferably 2.2-36.1 wt %, more preferably 2.47-20.1 wt %, particularly preferably 2.8-18.8 wt %, more particularly preferably 3.8-17.6 wt %, based on the total weight of the polyol composition.

Embodiment 4. A polyurethane reaction system, comprising:
Component A), comprising: at least one polyisocyanate;
Component B), comprising:
b1) at least one polyol;
b2) at least one compound having the structure of formula (I)

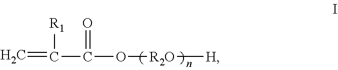

wherein, R₁ is selected from hydrogen, methyl or ethyl; R₂ is selected from an alkylene having 2-6 carbon atoms, 2,2-bis(4-phenylene)-propane, 1,4-bis(methylene)benzene, 1,3-bis(methylene)benzene, 1,2-bis(methylene)benzene; n is selected from an integral number of 1-6;
b3) at least one hydroxyl-free multifunctional (meth)acrylate;
Component C), a free radical reaction initiator.

Embodiment 5. The polyurethane reaction system according to embodiment 4, characterized in that the content of said b3) component is 1-18 wt %, preferably 1.2-16 wt %, more preferably 1.3-9.6 wt %, particularly preferably 1.5-9 wt %, more particularly preferably 2-8.5 wt %, based on the total weight of the polyurethane reaction system.

Embodiment 6. The polyurethane reaction system according to embodiment 4 or 5, characterized in that the polyurethane reaction system has a pot-life at 35° C. of ≥68 minutes, preferably ≥70 minutes, more preferably ≥72 minutes, particularly preferably ≥80 minutes.

Embodiment 7. The polyurethane reaction system according to any of embodiments 4-6, characterized in that compared to the pot-life at 35° C. of a polyurethane reaction system without b3), the pot-life at 35° C. of said polyurethane reaction system with b3) is increased by ≥5%, preferably ≥10%, more preferably ≥15%.

Embodiment 8. The polyurethane reaction system according to any of embodiments 4-7, characterized in that the polyurethane reaction system has a linear shrinkage rate of ≤0.95%, preferably ≤0.90%, more preferably ≤0.80% (Test Method ISO2577-2007).

Embodiment 9. A polyurethane resin, obtained from the reaction of the polyurethane reaction system according to any of embodiments 4-8.

Embodiment 10. Use of the polyurethane reaction system according to any of embodiments 4-8 in manufacture of wind blades.

Embodiment 11. A process for preparing a polyurethane composite, which is to prepare the polyurethane composite by mixing the following components:
The polyurethane reaction system according to any of embodiments 4-8; and
At least one reinforcing material.

Embodiment 12. The process according to embodiment 11, characterized in that the polyurethane composite is prepared through pultrusion process, filament winding process, hand lay-up moulding process, vacuum infusion process, spray lay-up moulding process or a combination thereof, preferably through pultrusion process and/or vacuum infusion process.

Embodiment 13. The process according to embodiment 11 or 12, characterized in that the process comprises the coexistence of the free radical polymerization reaction and the addition polymerization reaction between isocyanate groups and hydroxyl groups.

Embodiment 14. The process according to any of embodiments 11-13, characterized in that the polyurethane reaction system has a pot-life at 35° C. of ≥68 minutes, preferably ≥70 minutes, more preferably ≥72 minutes, particularly preferably ≥80 minutes.

Embodiment 15. The process according to any of embodiments 11-14, characterized in that compared to the pot-life at 35° C. of a polyurethane reaction system without b3), the pot-life at 35° C. of said polyurethane reaction system with b3) is increased by ≥5%, preferably ≥10%.

Embodiment 16. The process according to any of embodiments 11-15, characterized in that the polyurethane reaction system has a linear shrinkage rate of ≤0.95%, preferably ≤0.90%, more preferably ≤0.80% (Test Method ISO2577-2007).

Embodiment 17. A polyurethane composite obtained by the process for preparing a polyurethane composite according to any of embodiments 11-16.

Embodiment 18. The polyurethane composite according to embodiment 17, characterized in that the content of the reinforcing material in the polyurethane composite is ≥40 wt %, preferably ≥45 wt %, more preferably 50-88 wt %, based on the total weight of the polyurethane composite.

Embodiment 19. A polyurethane product, comprising the polyurethane resin of embodiment 9, characterized in that the polyurethane product is selected from cable trays, frames of doors, windows and curtain walls, frames of ladders, tent poles or pipes, anti-glare shields, floors, sucker rods, telegraph poles and cross arms, guardrails, grills, architectural sectional materials, container sectional materials and plates, bike racks, fishing rods, cable cores, insulator core rods, antenna housings, single-layer or sandwiched continuous plates, wind blades and parts thereof, enclosures for wind-driven generators, ship blades, ship shells, internal and external decorations and shells of vehicles, radar housings, structural part materials of mechanical equipment, decorations and structural parts of buildings and bridges, preferably wind blades or parts thereof, enclosures for wind-driven generators, more preferably blade shells, web, spar caps, main spars, auxiliary spars and blade roots of wind blades.

The present invention will be further described with reference to the specific examples. It is to be understood, however, that these examples are illustrative only and are not to be construed to limit the scope of the present invention.

### EXAMPLES

The test methods for which no specific conditions are indicated in the following examples are generally based on conventional conditions or according to conditions recommended by the manufacturer. Unless otherwise stated, all percentages and parts are by weight.

Pbw, refers to the parts by weight of each component in the polyurethane reaction system:

Functionality, refers to the value determined according to the industry formula: functionality-hydroxyl value * molecular weight/56100; wherein the molecular weight is determined by the GPC high performance liquid chromatography; Pot-life refers to the time from stirring the components of the reaction system uniformly until the viscosity of the mixture reaches 600 mPa·S. The pot-life can be measured in the following manner: Components of the polyurethane reaction system are thermostatically treated at 35° C. respectively, and then mixed in the required proportion: the mixture is stirred for 1 minute until the mixture is mixed uniformly; under the temperature being maintained at 35° C., the viscosity of the mixture is measured once every 3 minutes, and the time required until the viscosity reaches 600 mPa·S is recorded as the pot-life. The viscometer is a product from Brook-Field Corporation, Model DV2TLTJ0.

Linear shrinkage rate refers to the linear shrinkage rate of a resin obtained from the reaction of a polyurethane reaction system measured according to test standard ISO 2577-2007. The specific method in the present invention can be as follows: the components of the polyurethane reaction system are prepared in proportion, the polyurethane reaction system is placed into a semi-cylinder mould which has been preheated to 35° C. in an oven, the length of the liquid level in the semi-cylinder mould is recorded as hl, then the temperature is uniformly and slowly raised to 70° C. within 2 hours, and then the temperature is constantly kept at 70° C. for 4 hours. After cooling to room temperature (e.g., 25° C.), the length h2 of the polyurethane resin is measured, and the linear shrinkage rate is determined and calculated as follows: (h1−h2)/h1×100%.

Isocyanate index, refers to a value calculated by the following formula:

$$Isocyanate index ( \% ) = \frac{mole number of isocyanate group ( NCO ) group in component A}{\begin{matrix}mole number of isocyanate group - \\ reactive group in component B\end{matrix}} \times 100$$

The raw materials used in the examples are as follows:
Isocyanate: Desmodur 1511L, NCO wt %: 30.5-32.5 wt %, viscosity at 25° C.: 160-240 mP·s, purchased from Covestro Polymers (China) Co., Ltd.:
Free-radical reaction initiator: t-butyl peroxybenzoate (TBPB), purchased from AkzoNobel;
Accelerator: NL-49P, purchased from AkzoNobel;
Polyol: propylene oxide-based polyether polyols, the starter is glycerol, functionality =3, hydroxyl value 350 mg KOH/g, purchased from Covestro Polymers (China) Co., Ltd.;
Hydroxypropyl methacrylate (HPMA): purchased from Hersbit Chemical;
1,6-hexylene glycol diacrylate (HDDA): purchased from Aladdin;
Trimethylolpropane trimethacrylate (TMPTMA): purchased from Aladdin.

### Examples E1-4 and Comparative Example C1

Preparation of a polyol material (component B): According to the component proportions in Table 1, the polyol, HPMA, NL-49P and HDDA were weighed, successively added to a plastic cup, stirred to become uniform, then placed into a 35° C. oven and thermostatically treated.

Preparation of a isocyanate material (component A): According to the component proportions in Table 1, TBPB and 1511L were weighed, successively added to another plastic cup, stirred to become uniform, then also placed into a 35° C. oven and thermostatically treated.

The isocyanate and polyol materials were quickly weighed according to the proportions in Table 1, placed in a new plastic cup, and quickly stirred to become uniform (the total weight of the isocyanate and polyol materials was 300 g). Then, the mixture was placed in a 35° ° C. water-bath box, the change in viscosity along with the time and the temperature was monitored, and its pot-life was measured.

The linear shrinkage rate was measured according to the test standard ISO2577-2007 and the aforementioned steps.

The test results were shown in Table 1.

TABLE 1
Mass parts of the components and test results of Examples
E1-4 and Comparative Example C1 (unit: bpw for mass part)

| | C1 | E1 | E2 | E3 | E4 |
|---|---|---|---|---|---|
| Polyol | 60 | 60 | 60 | 60 | 60 |
| HPMA | 40 | 40 | 40 | 40 | 40 |
| NL-49P | 0.1 | 0.1 | 0.1 | 0.1 | 0.1 |
| HDDA | | 10 | 15 | 25 | 35 |
| 1511L | 87 | 87 | 87 | 87 | 87 |
| TBPB | 1.6 | 1.6 | 1.6 | 1.6 | 1.6 |
| Pot-life (35° C.) | 67 | 85 | 99 | 126 | 155 |
| Linear shrinkage | 0.65% | 0.65% | 0.65% | 0.71% | 0.75% |
| rate | | | | | |

It could be seen from the experimental results of Table 1 that compared to Comparative Example 1, Examples 1˜4 in which HDDA was added could significantly extend their pot-lifes and simultaneously could increase their linear shrinkage rates too. Based on different applications, the proper mass proportion of components could be selected to achieve the balance of the pot-life and the linear shrinkage rate so as to meet different requirements.

### Examples E5-8 and Comparative Example C1

Preparation of a polyol material (component B): According to the component proportions in Table 2, the polyol, HPMA, NL-49P and TMPTMA were weighed, successively added to a plastic cup, stirred to become uniform, then placed into a 35° C. oven and thermostatically treated.

Preparation of a isocyanate material (component A): According to the component proportions in Table 2, TBPB and 1511L were weighed, successively added to another plastic cup, stirred to become uniform, then also placed into a 35° C. oven and thermostatically treated.

The isocyanate and polyol materials were quickly weighed according to the component proportions in Table 2, placed in a new plastic cup, and quickly stirred to become uniform (the total weight of the isocyanate and polyol materials was 300 g). Then, the mixture was placed in a 35° C. water-bath box, the change in viscosity along with the time and the temperature was monitored, and its pot-life was measured.

The linear shrinkage rate was measured according to the test standard ISO2577-2007 and the aforementioned steps.

The test results were shown in Table 2.

TABLE 2
Test results of Examples E5-8 and Comparative Example C1

| | C1 | E5 | E6 | E7 | E8 |
|---|---|---|---|---|---|
| Polyol | 60 | 60 | 60 | 60 | 60 |
| HPMA | 40 | 40 | 40 | 40 | 40 |
| NL-49P | 0.1 | 0.1 | 0.1 | 0.1 | 0.1 |
| TMPTMA | | 10 | 15 | 25 | 35 |
| 1511L | 87 | 87 | 87 | 87 | 87 |
| Tc | 1.6 | 1.6 | 1.6 | 1.6 | 1.6 |
| Pot-life (35° C.) | 67 | 82 | 82 | 99 | 110 |
| Linear shrinkage rate | 0.65% | 0.66% | 0.66% | 0.69% | 0.78% |

It could be seen from Table 2 that compared to Comparative Example 1, Examples 5-8 in which TMPTMA was added could significantly extend their pot-lifes and simultaneously could increase their linear shrinkage rates too. The proper mass proportion of components could be selected to achieve the balance of the pot-life and the linear shrinkage rate so as to meet different requirements.

### Example 2

A unidirectional fiber cloth, model UD1200, was laid on a platform with an electric heating plate, with 60 layers of glass fiber being laid: a release cloth/guiding net/vacuum bag, etc. were preset as required, and a injection port was installed, with the temperature being controlled to 35° C., turning on the vacuum, and the pressure being set to −0.1 MPa.

The preparation of polyurethane resin: component A and component B were prepared according to the formulations in Table 1 and Table 2, respectively: the component A and the component B (each 8 kinds, corresponding to Examples E1-E8 respectively) were taken out, and mixed according to the component proportions in the Tables, and stirred evenly. The uniformly mixed compositions were put into a vacuum defoaming machine to vacuum defoam for 10 min at a vacuum pressure of −0.095 MPa.

Infusion and glue injection: a glue guide tube was inserted into the defoamed polyurethane composition, after releasing the locking clip of the glue guide tube, the polyurethane resin was poured into the glass fiber under the action of vacuum. The locking clip of the glue guide tube was turn off after completion of the pouring. With the vacuum being continually turned on, the heating plate was set to 50° C. for 2 hours and then the temperature was increased to 70° C. for 4 hours.

The vacuum equipment and the heating plate were turned off, and after the product was cooled to room temperature, the FRP of the polyurethane resin, i.e., the FRP composite was obtained by demoulding. The composites corresponding to Examples E1-E8 can all meet the processing requirements.

For comparison, product corresponding to C1 was prepared in the same way. In contrast, C1, which has a pot-life of 67 minutes, cannot be filled up in the above way.

1. A polyurethane composite prepared by a process comprising mixing the following components:
a polyurethane reaction system, and
at least one reinforcing material;
wherein, the process comprises a pultrusion process, a filament winding process, a hand lay-up moulding process, a vacuum infusion process, a spray lay-up moulding process or a combination thereof;
wherein the polyurethane reaction system comprises:
component A), comprising at least one polyisocyanate,
component B), comprising:
b1) at least one polyol;
b2) at least one compound having the structure of formula (I) 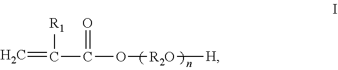
wherein, R₁ is selected from the group consisting of hydrogen, methyl and ethyl; R₂ is selected from the group consisting of an alkylene having 2-6 carbon atoms, 2,2-bis(4-phenylene)-propane, 1,4-bis(methylene)benzene, 1,3-bis(methylene)benzene, and 1,2-bis(methylene)benzene; and n is an integer having a value in a range of 1-6; and
b3) at least one hydroxyl-free multifunctional (meth)acrylate, and
component C), a free radical reaction initiator.

2. The polyurethane composite according to claim 1, wherein:
a functionality of the polyisocyanate is 2.0-3.5;
a viscosity of the polyisocyanate measured at 25° C. according to DIN 53019-1-3 is 5-700 mPa·S; and/or
a NCO content of the polyisocyanate determined according to GB/T 12009.4-2016 is 20-33 wt %.

3. The polyurethane composite according to claim 1, wherein:
said b1) component is selected from one or more organic polyol having a functionality of 1.7-6, and a hydroxyl value according to ISO 14900-2017 of 150-1100 mg KOH/g; and/or
the content of said b1) component is 9-60 wt % based on the total weight of the polyurethane reaction system.

4. The polyurethane composite according to claim 1, wherein:
said component b2) is selected from the group consisting of hydroxyethyl methacrylate, hydroxypropyl methacrylate, hydroxybutyl methacrylate, hydroxyethyl acrylate, hydroxypropyl acrylate, hydroxybutyl acrylate, and a combination thereof; and/or
the content of said b2) component is 3-34 wt % based on the total weight of the polyurethane reaction system.

5. The polyurethane composite according to claim 1, wherein:
said b3) component is selected from the group consisting of ethylene glycol di(meth)acrylate, propylene glycol di(meth)acrylate, butylene glycol di(meth)acrylate, 1,6-hexylene glycol di(meth)acrylate, diethylene glycol di(meth)acrylate, triethylene glycol di(meth)acrylate, dipropylene glycol di(meth)acrylate, tripropylene glycol di(meth)acrylate, trimethylolpropane tri(meth)acrylate, 1,2,3-glycerol tri(meth)acrylate, pentaerythritol tetra(meth)acrylate, and a combination thereof; and/or
the content of said b3) component is 1-18 wt % based on the total weight of the polyurethane reaction system.

6. The polyurethane composite according to claim 1, wherein the polyurethane reaction system meets one or more of the following:
the polyurethane reaction system has a pot-life at 35° C. of ≥68 minutes;
compared to a pot-life at 35° C. of a polyurethane reaction system without b3) component, the pot-life at 35° C. of said polyurethane reaction system with b3) component is increased by ≥5%; or
the polyurethane reaction system has a linear shrinkage rate according to ISO 2577-2007 of ≤0.95%.

7. The polyurethane composite according to claim 1, wherein the process for preparing the polyurethane composite comprises a pultrusion process and/or a vacuum infusion process.

8. The polyurethane composite according to claim 1, wherein the process for preparing the polyurethane composite comprises the coexistence of a free radical polymerization reaction and an addition polymerization reaction between isocyanate groups and hydroxyl groups.

9. The polyurethane composite according to claim 1, wherein the content of the at least one reinforcing material in the polyurethane composite is ≥40 wt % based on the total weight of the polyurethane composite.

10. The polyurethane composite according to claim 1, wherein the at least one reinforcing material in the polyurethane composite is selected from the group consisting of glass fiber, carbon nanotube, carbon fiber, polyester fiber, natural fiber, aromatic polyamide fiber, nylon fiber, basalt fiber, boron fiber, silicon carbide fiber, asbestos fiber, crystal whisker, hard particles, metal fiber and any combination thereof.

11. A polyurethane product comprising the polyurethane composite according to claim 1, characterized in that wherein the polyurethane product is selected from the group consisting of cable trays, frames of doors, windows and curtain walls, frames of ladders, tent poles or pipes, anti-glare shields, floors, sucker rods, telegraph poles and cross arms, guardrails, grills, architectural sectional materials, container sectional materials and plates, bike racks, fishing rods, cable cores, insulator core rods, antenna housings, single-layer or sandwiched continuous plates, wind blades and parts thereof, enclosures for wind-driven generators, ship blades, ship shells, internal and external decorations and shells of vehicles, radar housings, structural part materials of mechanical equipment, and decorations and structural parts of buildings and bridges.

12. A method comprising preparing a polyurethane produce with the polyurethane composite according to claim 1, wherein the polyurethane product is selected from the group consisting of cable trays, frames of doors, windows and curtain walls, frames of ladders, tent poles or pipes, anti-glare shields, floors, sucker rods, telegraph poles and cross arms, guardrails, grills, architectural sectional materials, container sectional materials and plates, bike racks, fishing rods, cable cores, insulator core rods, antenna housings, single-layer or sandwiched continuous plates, wind blades and parts thereof, enclosures for wind-driven generators, ship blades, ship shells, internal and external decorations and shells of vehicles, radar housings, structural part materials of mechanical equipment, and decorations and structural parts of buildings and bridges.

13. The polyurethane composite according to claim 2, wherein the functionality of the isocyanate is 2.1-2.9.

14. The polyurethane composite according to claim 2, wherein the viscosity of the polyisocyanate measured at 25° C. according to DIN 53019-1-3 is 10-300 mPa·S.

15. The polyurethane composite according to claim 2, wherein the NCO content of the polyisocyanate determined according to GB/T 12009.4-2016 is 30-32 wt %.

16. The polyurethane composite according to claim 1, wherein the at least one polyisocyanate comprises toluene diisocyanate (TDI), diphenylmethane diisocyanate (MDI), polyphenylmethane polyisocyanate (pMDI), 1,5-naphthalene diisocyanate (NDI), hexamethylene diisocyanate (HDI), methylcyclohexyl diisocyanate (TDI), 4,4′-dicyclohexylmethane diisocyanate, isophorone diisocyanate (IPDI), p-phenylene diisocyanate (PPDI), p-xylylene diisocyanate (XDI), or tetramethyldimethylene diisocyanate (TMXDI), or any polymer thereof, or a combination thereof.

17. The polyurethane composite according to claim 3, wherein said b1) component is a propylene oxide-based polyether polyol prepared with a glycerol starter, a propylene oxide-based polyether polyol comprising a functionality of 3 and a hydroxyl value of 350 mg KOH/g.

18. The polyurethane composite according to claim 3, wherein the content of said b1) component is 10-60 wt % based on the total weight of the polyurethane reaction system.

19. The polyurethane composite according to claim 4, wherein said component b2) is hydroxypropyl methacrylate.

20. The polyurethane composite according to claim 4, wherein the content of said b2) component is 5-33 wt % based on the total weight of the polyurethane reaction system.
